(19) United States
(12) Patent Application Publication
(10) Pub. No.: US 2005/0129853 A1
(43) Pub. Date: Jun. 16, 2005

(54) Nano photocatalyst coating procedure

(76) Inventor: Ming-Theng Wang, Chung Ho City (TW)

Correspondence Address: Ming-Theng Wang, PO Box 82-144, Taipei, TW

(21) Appl. No.: 10/735,920

(22) Filed: Dec. 16, 2003

(51) Int. Cl. B05D 3/12; B05D 3/02

(52) U.S. Cl. 427/355; 427/372.2

(57) ABSTRACT

A nano photocatalyst coating procedure of forming a nano photocatalyst coating on the surface of a workpiece by: a). applying a nano photocatalyst solution of nano titanium dioxide and zinc oxide to the surface of the workpiece to form a nano photocatalyst coating, b). heating the workpiece to melt zinc oxide of the nano photocatalyst coating without melting nano titanium dioxide, and c). polishing the coating to press nano titanium dioxide into recesses at the surface of the workpiece and to let nano titanium dioxide be bonded to recesses at the surface of the workpiece by molten zinc oxide.

### BACKGROUND OF THE INVENTION

1. Field of the Invention

The present invention relates to a coating method and, more particularly to a nano photocatalyst coating procedure, which enables nano titanium dioxide to be bonded to the surface of the workpiece, forming a protection coating that prevents adherence of dust and provides a photocatalytic sterilizing function.

2. Description of the Related Art

Photocatalyst technology can effectively treats chlorobenzene organics, chlorophenol compound, cyanide compound, metal ions, and other pollutants in liquid phase waste materials. Photocatalyst technology can also effectively treats nitrogen oxide, sulfur dioxide in water gas. Because photocatalyst acts as a catalyzer in the reaction, it will not be used up and will not produce bad side effect. Therefore, photocatalyst technology is practical for air and river pollution protection. Further, when put semiconductor catalyst (for example, titanium dioxide) in water and radiate the water with ultraviolet rays, the water will be decomposed into oxygen and hydrogen. This reaction of converting light energy into chemical energy is similar to plants' photosynthesis. This method was used to produce hydrogen during oil crisis. However, due to low efficiency, this method is still under study for commercialization.

The principle of “Photocatalyst reaction” is to radiate photocatalyst with ultraviolet rays or sunlight, causing electrons to absorb sufficient energy and to escape from the surface of photocatalyst. Thus, electron holes carrying positive charges are formed at locations where electrons escaped. Electron holes oxidize surrounding free OH— (take electrons from free OH1), thereby causing free OH— to be changed to OH radicals of high mobility. When meeting organic substance, OH radials take electrons from organic substance, thereby causing organic substance collapse. Regular pollutants or virus are commonly composed of carbohydrate that produces not harmful water and carbon dioxide when deposed. Therefore, photocatalytic reaction can eliminate pollution and kill germs.

Various photocatalytic materials are known. These materials include oxygen compounds such as TiO₂, ZnO, SnO₂, and ZrO₂, and sulfur compounds such as CdS and ZnS. Among these photocatalytic materials, titanium dioxide (TiO₂) is the most invited one commonly used in nano photocatalytic electric home appliances, mouth masks, and other consumer goods since it was found in 1972, due to the advantages of high oxidization power, high chemical stability, and non-toxic nature.

A nanometer is 10⁻⁹ meter. In the natural world, the melting points of titanium and zinc are 1690° C. and 419.5° C. respectively. When making titanium dioxide into nano titanium dioxide particles, the melting point of the mixture of titanium dioxide and zinc oxide can be lowered to below 200° C. Further, the efficiency of photocatalytic reaction can be improved by greatly increasing the ratio between the surface area and the volume.

According to conventional photocatalyst application, a spray gun is used to spray-paint liquefied nano photocatalyst on the surface of a body. This method enables photocatalyst be maintained at the surface of the body for a certain length of time. However, when rubbing the surface of the body, the photocatalyst coating may be partially removed from the body, losing its photocatalytic effect. Further, coating a workpiece with a photocatalyst coating by spray painting simply enables the surface of the workpiece to provide a sterilizing function. It cannot make the surface of the workpiece finer to prevent adherence of dust.

### SUMMARY OF THE INVENTION

The present invention has been accomplished under the circumstances in view. It is the main object of the present invention to provide nano photocatalyst coating procedure, which is practical to form a nano photocatalyst coating at the surface of a workpiece, which nano photocatalyst coating prevents adherence of dust and provides a photocatalytic sterilizing function.

According to one aspect of the present invention, the nano photocatalyst coating procedure comprises the steps of: a). applying a nano photocatalyst solution prepared by mixing nano titanium dioxide with zinc oxide in a liquid to form a nano photocatalyst coating at the surface of a workpiece; b). heating the nano photocatalyst coating to melt zinc oxide without melting nano titanium dioxide; and c). polishing the nano photocatalyst coating to press nano titanium dioxide into recesses at the surface of said workpiece and to let nano titanium dioxide be bonded to recesses at the surface of the workpiece by molten zinc oxide. According to another aspect of the present invention, the workpiece can be a ceramic tile, glass member, metal plate member, or plastic plate member.

### BRIEF DESCRIPTION OF THE DRAWINGS

FIG. 1 is an enlarged view showing nano photocatalyst solution applied to the surface of the workpiece according to the present invention.

FIG. 2 is similar to FIG. 2 but showing excessive nano titanium dioxide and zinc oxide removed from the surface of the workpiece.

FIG. 3 is an enlarged plain view showing nano titanium dioxide particles bonded to recesses at the surface of the workpiece.

### DETAILED DESCRIPTION OF THE PREFERRED EMBODIMENT

The melting points of titanium and zinc are 169° C. and 419.5° c. respectively. By means of the application of nanotechnology, titanium dioxide is processed into nano titanium oxide particles. Thus, the melting point of the mixture of titanium dioxide and zinc oxide can be lowered to below 200° C. The invention uses this melting point changing characteristic to mix nano titanium oxide and zinc oxide into a solution and then to apply the solution to the workpiece, forming a coating at the workpiece.

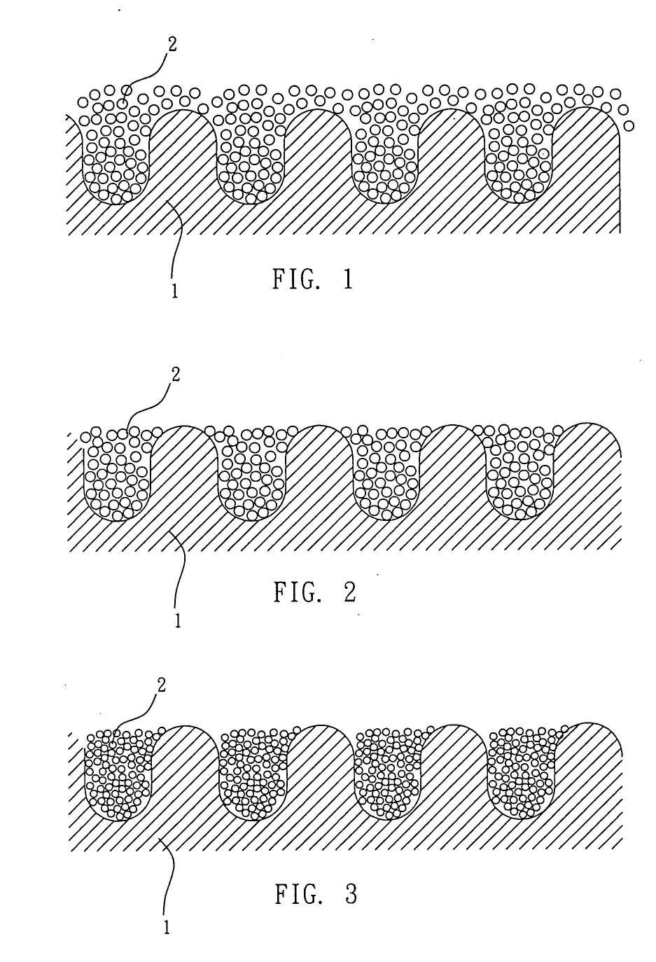

Referring to FIGS. 1˜3, a nano photocatalyst coating preparation procedure in accordance with the present invention comprises the steps of:
a). mixing nano titanium dioxide with zinc oxide in a liquid at the ratio of 1:1 to form a nano photocatalyst solution 2;
b). heating the surface of the workpiece 1 to a predetermined temperature level subject to the properties of the workpiece 1;
c). applying the nano photocatalyst solution 2 thus obtained from step a) to the surface of the workpiece 1 to form a coating on the surface of the workpiece;
d). heating the coating at the workpiece 1;
e). polishing the coating at the workpiece 1;
f). heating the coating at the workpiece 1 again to let titanium dioxide particles be positively embedded in recess in the surface of the workpiece 1; and
g) finishing the finished product.

The liquid in which nano titanium dioxide and zinc oxide were mixed can be pure water, deionized water, water wax, or any of a variety of solutions dissolvable in ethanol.

If the workpiece to be processed is a ceramic tile or a glass member, the ceramic tile or glass member is heated to about 200° C., and then the prepared nano photocatalyst solution is applied to the surface of the ceramic tile or glass member, and then the coated ceramic tile or glass member is delivered to a baking stove with the heating temperature set at 200° C. to heat nano photocatalyst solution to a gel-like status, and then the ceramic tile or glass member is cooled down and then surface-treated through a polishing process, causing titanium dioxide and zinc oxide to be pressed into recesses in the surface of the ceramic tile or glass member and excessive titanium dioxide and zinc oxide to be removed from the surface of the ceramic tile or glass member, so as to keep the surface of the ceramic tile or glass member smooth and bright, and then the polished ceramic tile or glass member is heated to about 500˜600° C. to melt zinc oxide and to let titanium dioxide particles be bonded to the recesses in the surface of the ceramic tile or glass member by the molten zinc oxide. Thus, the finished ceramic tile or glass member has a fine and smooth surface that prevents adherence of dust and provides a photocatalytic sterilizing function.

If the workpiece to be processed is a metal plate member, the metal plate member is heated to about 150° C., and then the prepared nano photocatalyst solution is applied to the surface of the metal plate member, and then the coated metal plate member is delivered to a baking stove with the heating temperature set at 150° C. to heat nano photocatalyst solution to a gel-like status, and then the metal plate member is cooled down and then surface-treated through a polishing process, causing titanium dioxide and zinc oxide to be pressed into recesses in the surface of the metal plate member and excessive titanium dioxide and zinc oxide to be removed from the surface of the metal plate member, so as to keep the surface of the metal plate member smooth and bright, and then the polished metal plate member is heated to about 200˜210° C. to melt zinc oxide and to let titanium dioxide particles be bonded to the recesses in the surface of the metal plate member by the molten zinc oxide. Thus, the finished metal plate member has a fine and smooth surface that prevents adherence of dust and provides a photocatalytic sterilizing function.

If the workpiece to be processed is a plastic plate member, the plastic plate member is heated to about 70˜180° C., and then the prepared nano photocatalyst solution is applied to the surface of the plastic plate member, and then the coated plastic plate member is delivered to a baking stove with the heating temperature set within 70˜80° C. to heat nano photocatalyst solution to a gel-like status, and then the plastic plate member is cooled down and then surface-treated through a polishing process, causing titanium dioxide and zinc oxide to be pressed into recesses in the surface of the plastic plate member and excessive titanium dioxide and zinc oxide to be removed from the surface of the plastic plate member, so as to keep the surface of the plastic plate member smooth and bright, and then the polished plastic plate member is heated to about 120˜150° C. to melt zinc oxide and to let titanium dioxide particles be bonded to the recesses in the surface of the plastic plate member by the molten zinc oxide. Thus, the finished plastic plate member has a fine and smooth surface that prevents adherence of dust and provides a photocatalytic sterilizing function.

Although particular embodiments of the invention have been described in detail for purposes of illustration, various modifications and enhancements may be made without departing from the spirit and scope of the invention. Accordingly, the invention is not to be limited except as by the appended claims.

1. A nano photocatalyst coating procedure comprising the steps of:
a). applying a nano photocatalyst solution prepared by mixing nano titanium dioxide with zinc oxide in a liquid to form a nano photocatalyst coating at the surface of a workpiece;
b). heating the coating at the workpiece to melt zinc oxide of said nano photocatalyst coating without melting nano titanium dioxide of said nano photocatalyst coating; and
c). polishing the coating at the workpiece to press nano titanium dioxide of said nano photocatalyst coating into recesses at the surface of the workpiece and to let nano titanium dioxide of said nano photocatalyst coating be bonded to recesses at the surface of said workpiece by molten zinc oxide.

2. The nano photocatalyst coating procedure, wherein said workpiece is a ceramic tile.

3. The nano photocatalyst coating procedure, wherein said workpiece is a glass member.

4. (canceled)

5. (canceled)
